(19) United States
(12) Patent Application Publication
(10) Pub. No.: US 2016/0378693 A1
(43) Pub. Date: Dec. 29, 2016

(54) INFORMATION PROCESSING APPARATUS AND PROGRAM EXECUTION METHOD

(71) Applicant: Kabushiki Kaisha Toshiba, Tokyo (JP)

(72) Inventors: Shunsuke Sasaki, Shinjuku Tokyo (JP); Toshiki Kizu, Yokohama Kanagawa (JP); Hiroshi Isozaki, Kawasaki Kanagawa (JP); Jun Kanai, Inagi Tokyo (JP); Shintarou Sano, Kawasaki Kanagawa (JP); Ryuta Nara, Kawasaki Kanagawa (JP)

(21) Appl. No.: 14/929,135

(22) Filed: Oct. 30, 2015

(30) Foreign Application Priority Data
Jun. 24, 2015 (JP) 2015-126277

(51) Int. Cl. G06F 12/14

(52) U.S. Cl. CPC G06F 12/1491; G06F 2212/1052

(57) ABSTRACT

According to one embodiment, an information processing apparatus includes a processor and a memory. The processor operates in a first state and a second state. The memory includes a first region and a second region. A first program code is written in the second region. The first program code is executed when a call of the function provided by an operation system is invoked. A second program code is written in the first region. The processor executes the second program code to replace a first instruction included in the first program code with a second instruction. The second instruction is for switching the second state and the first state.

### CROSS-REFERENCE TO RELATED APPLICATIONS

This application is based upon and claims the benefit of priority from Japanese Patent Application No. 2015-126277, filed on Jun. 24, 2015; the entire contents of which are incorporated herein by reference.

### FIELD

Embodiments described herein relate generally to an information processing apparatus and a program execution method.

### BACKGROUND

A technique used for information processing apparatuses has been known. The technique controls access to a memory by switching the security state among two or more security states. The enhancement of security of information processing apparatuses is required in order to prevent the information processing apparatus from incorrectly executing a program.

### BRIEF DESCRIPTION OF THE DRAWINGS

FIG. 1 is a block diagram of an information processing apparatus according to a first embodiment;

FIG. 2 is a flowchart of a process for modifying an NS-state exception handler code illustrated in FIG. 1;

FIG. 3 is a diagram of an exemplary NS-state exception handler code illustrated in FIG. 1;

FIG. 4 is a flowchart of a process when a supervisor call is sent in the first embodiment;

FIG. 5 is an explanatory diagram of exemplary program codes and exemplary transition of the process illustrated in FIG. 4;

FIG. 6 is a block diagram of an information processing apparatus according to a second embodiment;

FIG. 7 is a flowchart of a process for referring to an NS-state memory with a NS-state SVC check code illustrated in FIG. 6;

FIG. 8 is a block diagram of an information processing apparatus according to a third embodiment;

FIG. 9 is a diagram of an exemplary protection attribute table illustrated in FIG. 8;

FIG. 10 is a flowchart of a process for setting an access limitation by executing the memory protection controller setting code illustrated in FIG. 8;

FIG. 11 is a block diagram of an information processing apparatus according to a fourth embodiment; and

FIG. 12 is a flowchart of a process for the NS-state exception handler code in response to an interruption by a timer illustrated in FIG. 11.

### DETAILED DESCRIPTION

In general, according to one embodiment, the information processing apparatus includes a processor and a memory. The processor operates in a first state and a second state. The processor switches the first state and the second state. The second state has a security level lower than that of the first state. The memory includes a first region and a second region. The processor in the first state accesses the first region. The processor in the second state accesses the second region. A first program code is written in the second region. The first program code is executed when a call of the function provided by an operation system is invoked. A second program code is written in the first region. The second program code is for modifying the first program code. The processor executes the second program code to replace a first instruction included in the first program code with a second instruction. The second instruction is for switching the second state and the first state.

Exemplary embodiments of an information processing apparatus and a program execution method will be explained below in detail with reference to the accompanying drawings. The present invention is not limited to the following embodiments.

### First Embodiment

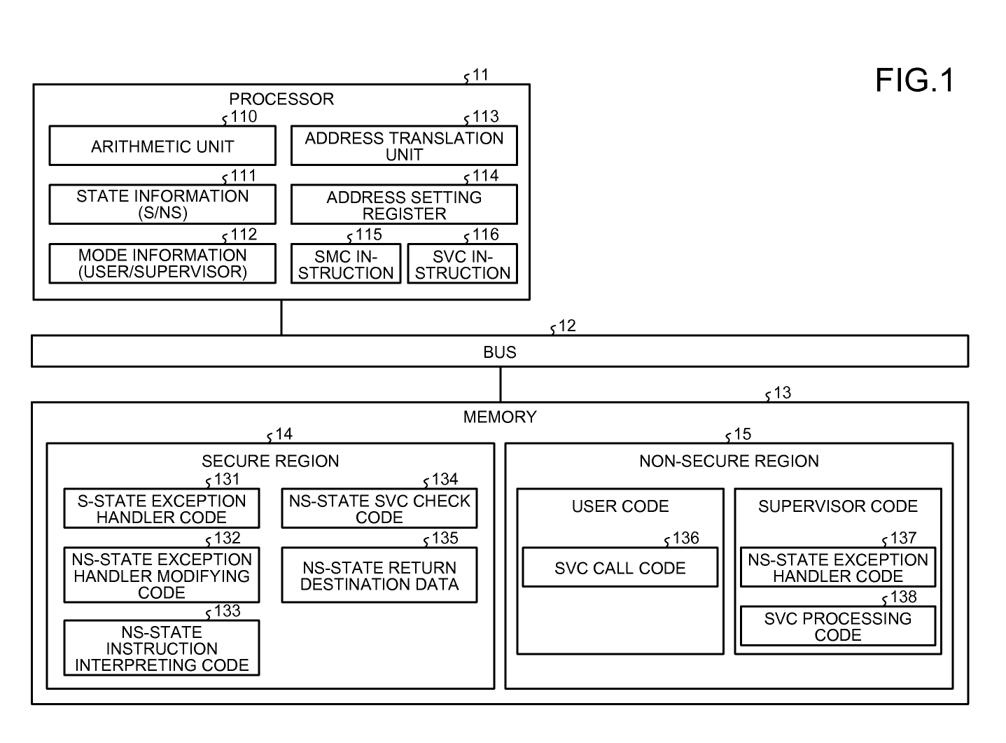

FIG. 1 is a block diagram of an information processing apparatus according to a first embodiment. The information processing apparatus includes a processor 11, a bus 12, and a memory 13. The processor 11 is connected to the memory 13 through the bus 12. FIG. 1 illustrates the hardware configuration of the information processing apparatus, various types of program codes and data stored or to be written in the hardware configuration.

The processor 11 sequentially executes an instruction loaded from the memory 13 and processes data. The processor 11 writes the results from the execution of the instruction and the data process to the memory 13.

The processor 11 includes an arithmetic unit 110, an address translation unit 113, and an address setting register 114. The arithmetic unit 110 performs an arithmetic operation to execute an instruction and process data. The address translation unit 113 executes an address translation between a virtual address and a physical address.

The processor 11 includes various registers. Each of the registers stores the data used in the execution of a program and the program counter. The program counter is a value indicating the memory address storing an instruction to be executed next. The address setting register 114 stores the address of an NS-state exception handler code 137.

The processor 11 operates while selectively switching the security state among two or more states having different security levels. A secure state that is a first state includes the highest security level. A non-secure state that is a second state includes the lowest security level. The processor 11 includes a function to separately execute the programs in the secure state and the non-secure state.

Note that the things related to the secure state are described with an “S-state” and the things related to the non-secure state are described with an “NS-state”.

The processor 11 switches the operation mode among two or more modes having different limitations on the operation. The supervisor mode is a first mode in which the system resource can be accessed without limitation in accordance with the security state. The information processing apparatus operates an operating system (OS) in the supervisor mode.

The user mode is a second mode in which access to the system resource is limited. The operation is limited in the user mode in comparison to in the supervisor mode. The information processing apparatus executes an application in the user mode.

A secure monitor mode is a third mode in which the operation for switching the state between the secure state and the non-secure state is allowed. When the state is switched between the secure state and the non-secure state, the processor 11 switches the operation mode to the secure monitor mode. The secure monitor mode is selected only in the secure state. The processor 11 can switch the operation mode to a mode other than the modes described in the present embodiment.

Each of the registers stores state information 111, mode information 112, a secure monitor call (SMC) instruction 115, and a supervisor call (SVC) instruction 116. The state information 111 indicates that the processor 11 is in the secure state or the non-secure state. The mode information 112 indicates that the processor 11 operates in the user mode or the supervisor mode.

The SMC instruction 115 and the SVC instruction 116 are included in an instruction set implemented in the processor 11. The SMC instruction 115 gives an instruction for switching the operation mode between the supervisor mode in the non-secure state and the secure monitor mode in the secure state. The SVC instruction 116 gives an instruction for switching the operation mode between the user mode and the supervisor mode in the non-secure state.

The memory 13 is a general-purpose main storage device. The memory 13 can be, for example, a DRAM, an SRAM, a NAND memory, or an MRAM. The memory 13 includes a secure region 14, and a non-secure region 15.

The secure region 14 that is a first region is a memory region which the processor 11 in the secure state accesses. The non-secure region 15 that is a second region is a memory region which the processor 11 in the non-secure state accesses. The access of the processor 11 in the non-secure state to the secure region 14 is limited.

Each of the program codes is written and developed in the memory 13 from an external storage device (not illustrated) when the information processing apparatus starts. The program code including an S-state exception handler code 131, an NS-state exception handler modifying code 132, an NS-state instruction interpreting code 133, and an NS-state SVC check code 134 is placed in the secure region 14. An NS-state return destination data 135 is placed in the secure region 14.

The S-state exception handler code 131 is a program code to be executed by the processor 11 in the secure state when an exception occurs. The NS-state exception handler modifying code 132 that is the second program code is for modifying a supervisor call handler. The supervisor call handler is included in the NS-state exception handler code 137 that is the first program code.

The NS-state instruction interpreting code 133 is a program code for interpreting an instruction included in the NS-state exception handler code 137. The NS-state SVC check code 134 is a program code for checking the contents of the process that a program requests to the OS using a supervisor call. A supervisor call is the function provided from the kernel of the OS and an instruction and information that is called for using the function.

The user code and the supervisor code are placed in the non-secure region 15. The user code is the program code in the user mode executed on the OS. The supervisor code is the program code in the supervisor mode executed on the OS.

The information processing apparatus invokes a supervisor call as necessary while a program is executed in the user mode. The information processing apparatus returns to the process previously performed when a process by a desired function is performed in the supervisor mode.

The user code includes an SVC call code 136. The supervisor code includes the NS-state exception handler code 137 and an SVC processing code 138. The SVC call code 136 is for invoking a supervisor call.

The NS-state exception handler code 137 is a program code executed by the processor 11 in the non-secure state when an exception occurs. The SVC processing code 138 is a program code for performing a process using a supervisor call.

In the information processing apparatus, the application executed in the non-secure state sometimes sends a request for a process using the function of the OS. The information processing apparatus according to the present embodiment verifies the validity of the invoking of the supervisor call, using a program executed in the secure state. The information processing apparatus modifies the NS-state exception handler code 137 as the preparation for switching the non-secure state to the secure state. The information processing apparatus evacuates a predetermined data item in order to return to the previous operation after the verification.

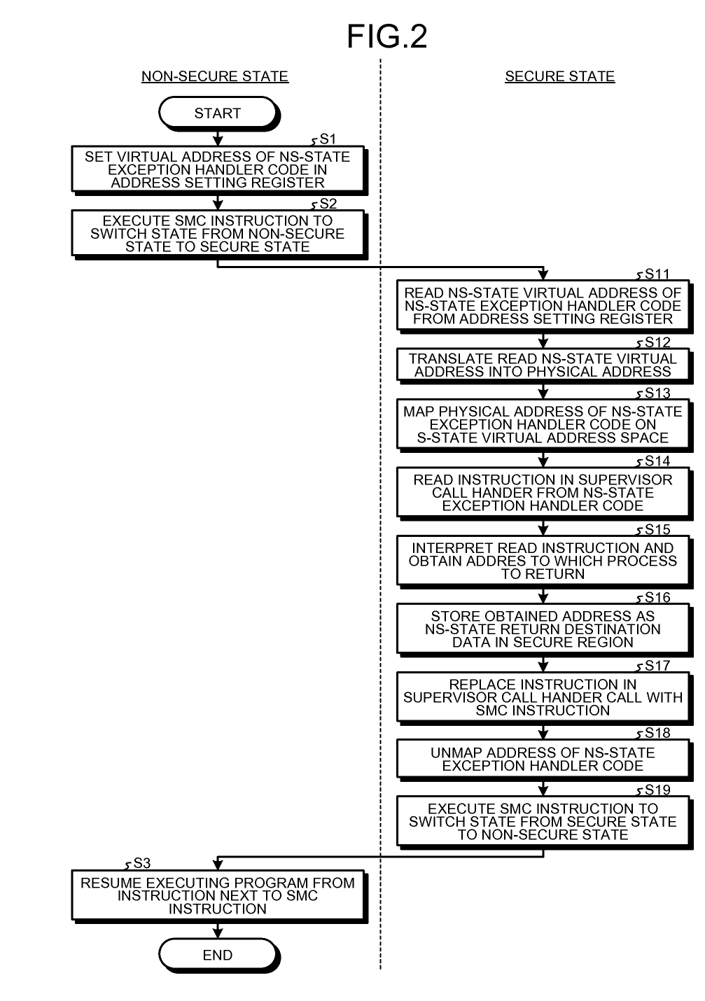

FIG. 2 is a flowchart of a process for modifying the NS-state exception handler code. The processor 11 sets a virtual address of the NS-state exception handler code 137 in the non-secure state as a process at the time of a normal start of the OS (S1).

The address setting register 114 stores the set virtual address. The virtual address is the NS-state virtual address that the processor 11 in the non-secure state can recognize. The processor 11 starts executing a program in the non-secure state after completing the process at the start.

When a process in the secure state is required during the execution of a program in the non-secure state, the processor 11 executes the SMC instruction 115 in response to the secure monitor call. The processor 11 switches the non-secure state to the secure state (S2). The processor 11 calls the S-state exception handler code 131 from the secure region 14 in the secure state.

The S-state exception handler code 131 includes an instruction for calling the NS-state exception handler modifying code 132. The processor 11 executes the called S-state exception handler code 131 to call the NS-state exception handler modifying code 132 from the secure region 14. The processor 11 executes the NS-state exception handler modifying code 132 to perform the process from S11 to S19.

The processor 11 reads the NS-state virtual address of the NS-state exception handler code 137 from the address setting register 114 (S11). The address translation unit 113 translates the read NS-state virtual address into the physical address in accordance with the rule of the translation in the non-secure state (S12). The address translation unit 113 can translate the NS-state virtual address into the physical address in accordance with an NS-state page table storing the mapping of the NS-state virtual address and the physical address.

The address translation unit 113 maps the physical address on an S-state virtual address space in accordance with the rule of the translation in the secure state (S13). The address translation unit 113 can rewrite the S-state page table storing the mapping of the S-state virtual address and the physical address.

After the process in S12 and S13, the processor 11 can read the data from the region storing the NS-state exception handler code 137 and write the data to the region in the secure state. The processor 11 reads an instruction in the supervisor call handler from the NS-state exception handler code 137 (S14). The supervisor call handler is the program code that starts when a supervisor call is invoked.

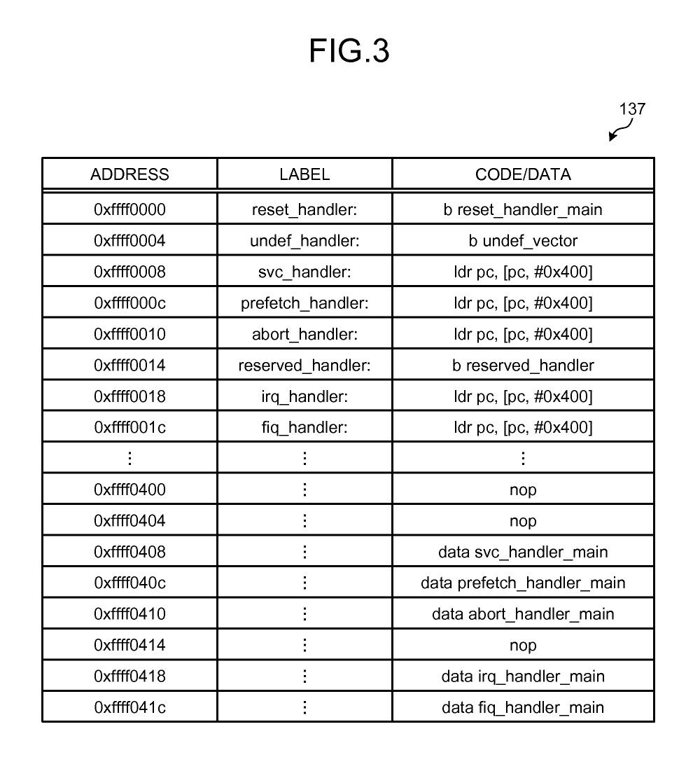

FIG. 3 is a diagram of an exemplary NS-state exception handler code. The NS-state exception handler code 137 includes a part in which an instruction for each type of exceptions is written and the other parts. In the example, the label “svc_handler:” of the address “0xffff0008” indicates a supervisor call handler.

Note that the address setting register 114 stores the NS-state virtual address “0xffff0000” of the NS-state exception handler code 137. In the example, it is determined in the processor 11 that the “svc_handler:” is stored in the address obtained by adding an offset value “eight” to the NS-state virtual address of the NS-state exception handler code 137.

A supervisor call handler indicates the “ldc pc, [pc,#0x400]” as the code and data. The indication is an instruction for loading, to the program counter (PC), the data indicated in the memory address “0xffff0408” that is obtained by adding “0x400” to “0xffff0008” that is the address of the instruction. The instruction is the first instruction included in the supervisor call handler. When the first instruction is executed, the process in the processor 11 jumps to the “svc_handler main” indicated in the address “0xffff0408”.

The processor 11 interprets the contents of the instruction read in S14 illustrated in FIG. 2 in accordance with the NS-state instruction interpreting code 133. The processor 11 obtains the address that is the destination to which the process returns in accordance with the interpretation (S15). In the example illustrated in FIG. 3, the processor 11 obtains the “svc_handler main” that is the data indicating the return destination address in accordance with the contents of the “ldc pc, [pc,#0x400]”.

The processor 11 stores the obtained address as the NS-state return destination data 135 in the secure region 14 (S16). The processor 11 stores the data obtained from the interpretation by the first instruction in the secure region 14. The processor 11 evacuates the data indicating the return destination address to a predetermined region in the memory 13.

The processor 11 replaces the first instruction in the supervisor call handler in the NS-state exception handler code 137 with an SMC instruction that is the second instruction (S17). In the example illustrated in FIG. 3, the processor 11 replaces the instruction “ldc pc, [pc,#0x400]” of the address “0xffff0008” with the SMC instruction 115.

After replacing the instruction in S17, the processor 11 unmaps the address of the NS-state exception handler code 137 in S13 (S18). The processor 11 executes the SMC instruction 115. The processor 11 switches the secure state to the non-secure state (S19). The processor 11 resumes executing the program in the non-secure state from the instruction next to the SMC instruction 115 executed in S2 (S3).

Next, a trap operation when a supervisor call is invoked after the NS-state exception handler code 137 is modified will be described.

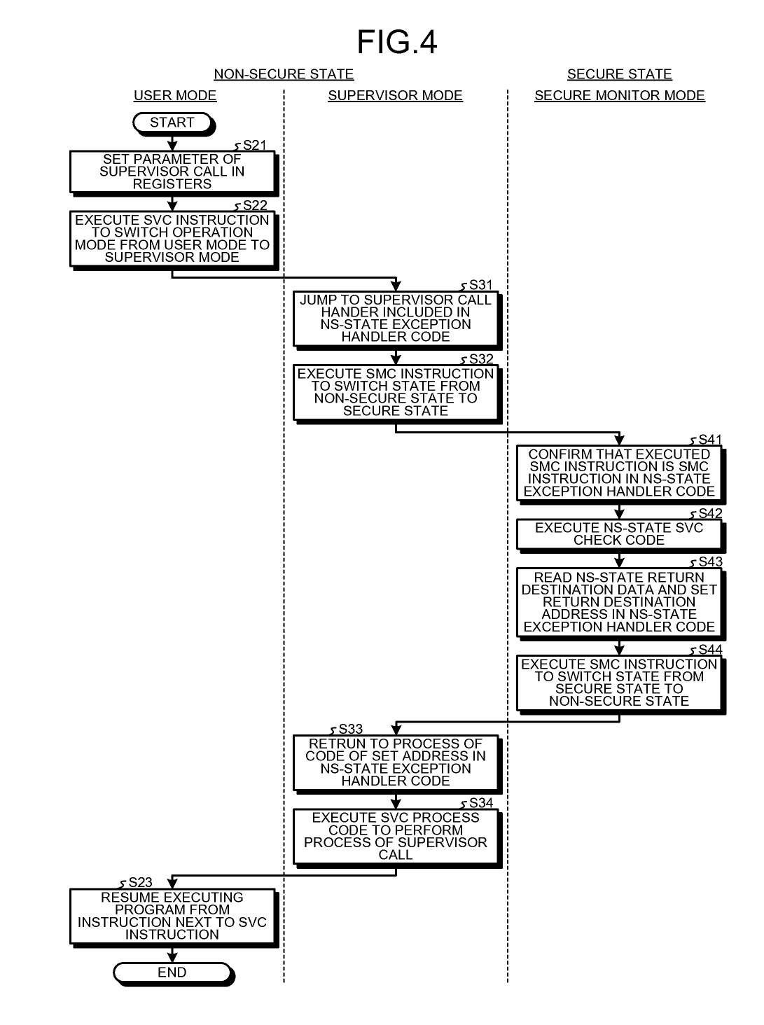

FIG. 4 is a flowchart of a process performed when a supervisor call is invoked in the first embodiment. The process described herein is performed when a supervisor call is invoked while a program is executed in the user mode.

The process illustrated in FIG. 4 is started by the execution of the SVC call code 136 included in the user code. The processor 11 executes the SVC call code 136 to set the parameter of the supervisor call in predetermined registers (S21).

The processor 11 performs the SVC instruction 116 (S22). The processor 11 switches the user mode to the supervisor mode. The code executed by the processor 11 jumps from the user code to the supervisor call handler (S31).

The procedures until the jump is in accordance with a standard method that a normal OS performs to invoke a supervisor call. A process requested by a supervisor call is performed in the supervisor mode as a standard process when a supervisor call is invoked.

The processor 11 according to the first embodiment executes the SMC instruction in the supervisor call handler in accordance with the modified NS-state exception handler code 137. The processor 11 switches the non-secure state to the secure state (S32). Meanwhile, the processor 11 switches the supervisor mode to the secure monitor mode.

The code executed by the processor 11 jumps from the NS-state exception handler code 137 to the S-state exception handler code 131. In other words, the information processing apparatus performs a process in accordance with the S-state exception handler code 131 instead of the process in accordance with the transition to the SVC processing code 138.

The processor 11 performs the process of the S-state exception handler code 131. The processor 11 confirms that the SMC instruction executed in S32 is the SMC instruction included in the NS-state exception handler code 137 (S41).

The processor 11 can compare the result obtained by adding a predetermined offset value to the address stored in the address setting register 114 with the address of the instruction before the code jumps to the S-state exception handler code 131. When the result corresponds to the address in the comparison, the processor 11 determines that the executed SMC instruction is the SMC instruction in the NS-state exception handler code 137. In the example illustrated in FIG. 3, the processor 11 refers to the result obtained by adding the offset value “eight” to the address “0xffff0000”.

When it is confirmed that the executed SMC instruction is the SMC instruction in the NS-state exception handler code 137, the processor 11 perform the process in and after S42. When it is not confirmed, the processor 11 determines that the executed SMC instruction is an instruction other than the SMC instruction in the NS-state exception handler code 137. Then, the processor 11 suspends the process in and after S42.

The processor 11 executes the supervisor call handler in the secure monitor mode after the confirmation in S41. The processor 11 reads the parameter set in the registers (S21). The processor 11 executes the NS-state SVC check code 134 to check the read parameter (S42).

The processor 11 performs a process based on the read parameter. For example, the processor 11 rewrites the parameter based on the read parameter. The processor 11 can record the parameter as an exemplary process based on the read parameter. The processor 11 can perform any one of the processes based on the read parameter.

The processor 11 can rewrite the SVC number included in the SVC call code 136 that is one of the parameters set in the register in S21 as an exemplary process in accordance with the read parameter. The SVC number indicates the contents of the process requested by the user code using a supervisor call. For example, when the SVC number included in the SVC call code 136 is a specific value, the processor 11 rewrites the SVC number that is the specific number with another value. The processor 11 stores the rewritten value of the SVC number in the register.

As an specific example of the rewriting of the SVC number, the processor 11 replaces the specific value requesting the process, which needs to be prevented from being executed for security, with a value that does not originally exist as an SVC number. By this replacement, the processor 11 forcibly causes the supervisor call to be an error. The information processing apparatus can block the process disadvantageous for security from being performed.

As an exemplary process based on the read parameter, the processor 11 can record the parameter regardless of the value of the SVC number. The information processing apparatus can use the record of the parameter to verify the validity of the invoking of the supervisor call. In such a case, the information processing apparatus can also avoid the performance of the process disadvantageous for security.

The validity of the invoking of the supervisor call can be verified by any one of the programs executed in the secure state after the execution of the NS-state SVC check code 134. The verification can be included in the process performed by the execution of the NS-state SVC check code 134.

The processor 11 reads the NS-state return destination data 135 from the secure region 14 (S43). The NS-state return destination data 135 is the data of the return destination address evacuated in S16. The processor 11 sets the address indicated by the read NS-state return destination data 135 as the address of the return destination when the process returns to the process executed in accordance with the NS-state exception handler code 137 in the supervisor mode.

The processor 11 executes the SMC instruction 115. The processor 11 switches the secure state to the non-secure state (S44). Meanwhile, the processor 11 switches the secure monitor mode to the supervisor mode.

The process of the processor 11 returns to the code of the address set in S43 in the NS-state exception handler code 137 (S33). By this return, the processor 11 returns from the secure state to the process in accordance with the supervisor call handler in the non-secure state.

The processor 11 reads the SVC processing code 138 in accordance with the code of the address of the return destination. The processor 11 executes the read SVC processing code 138 to perform the process of the supervisor call (S34). The processor 11 performs the process based on the parameter read from the register. When the value of the SVC number is rewritten in S42, the processor 11 performs the process in accordance with the rewritten value.

After completing the process of the supervisor call, the processor 11 switches the supervisor mode to the user mode. The processor 11 resumes performing a program in the user mode from the instruction next to the SVC instruction 116 executed in S22 (S23).

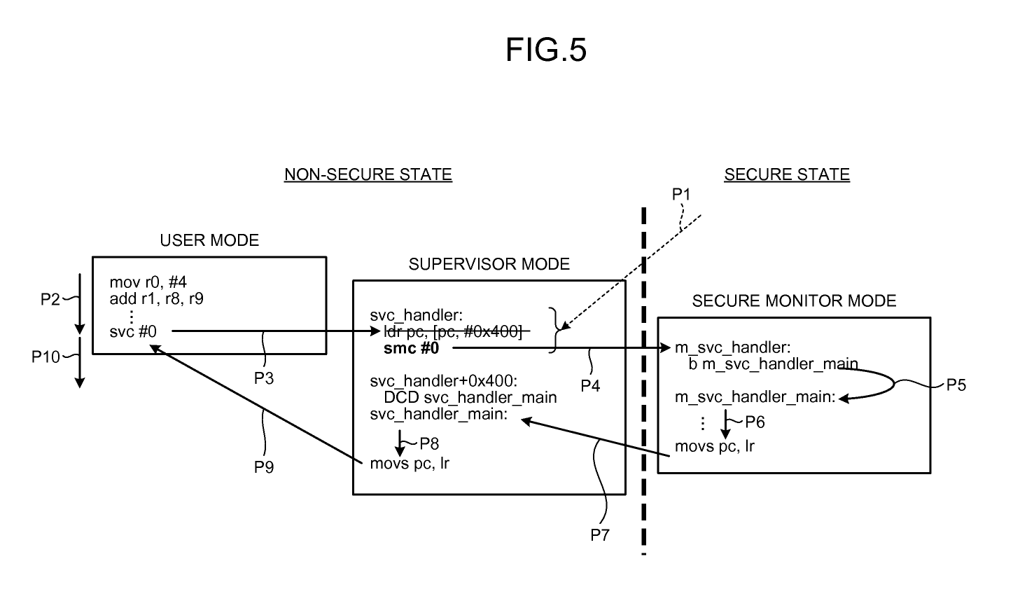

FIG. 5 is an explanatory diagram of the program codes of the process illustrated in FIG. 4 and the transition of the process. FIG. 5 illustrates each of exemplary program codes executed in the user mode, the supervisor mode, and the secure monitor mode.

The instruction “ldc pc, [pc,#0x400]” of the “svc_handler:” in the program codes in the supervisor mode is replaced with “smc #0” that is the SMC instruction by the process in the secure state in S17. The “P1” indicates the replacement of the instruction in the secure state.

The “svc #0” that is the SVC instruction 116 is executed in “P2” that is a process in which the program code is executed in the user mode. This shifts the process from the program code in the user mode to a supervisor call handler “svc_handler:” (“P3”).

The process is shifted from the handler “svc_handler:” in the supervisor mode to the supervisor call handler “m_svc_handler:” in the secure monitor mode by the “smc #0” replaced in the “P1” (“P4”).

When the handler “m_svc_handler:” starts, the process is shifted to the supervisor call handler “m_svc_handler_main:” in the secure monitor mode (“P5”).

The parameter of the supervisor call is checked in “P6” that is the process in which the supervisor call handler “m_svc_handler main:”. The parameter is rewritten as necessary.

After the supervisor call handler “m_svc_handler_main:” is executed, the return instruction in the S-state exception handler code 131 is executed. This execution shifts the process from the program code in the secure monitor mode to the previous handler “svc_handler_main:” (“P7”).

The process of the supervisor call is performed in the supervisor mode in “P8” that is the process in which the handler “svc_handler_main:” is executed by the kernel.

After the handler “svc _handler_main:” is executed, the return instruction in the NS-state exception handler code 137 is executed. This execution shifts the process from the program code in the supervisor mode to the program code in the user mode (“P9”). The process “P10” in which the program code is executed in the user mode is continued from the instruction next to the “svc #0”.

The information processing apparatus according to the first embodiment executes the NS-state exception handler modifying code 132 in the secure state. The information processing apparatus replaces the first instruction included in the supervisor call handler with an SMC instruction that is the second instruction. When a program is executed in the non-secure state and a supervisor call is invoked, the processor 11 switches the non-secure state to the secure state in accordance with the replaced instruction. The process performed by processor 11 is shifted from the execution of the NS-state exception handler code 137 in the supervisor mode to the S-state exception handler code 131 in the secure monitor mode. The information processing apparatus returns to the operation in the non-secure state through the operation in the secure state.

The processor 11 monitors the contents of the process requested in the user mode by checking the contents of the supervisor call in the secure state. The information processing apparatus can avoid the operation disadvantageous for security by performing the process in accordance with the results from the check. The processor 11 verifies the validity of the invoking of a supervisor call with the secure-state program. The information processing apparatus can prevent a supervisor call with low validity from being invoked in accordance with the verification. As described above, the information processing apparatus have the effect of enhancing the security.

### Second Embodiment

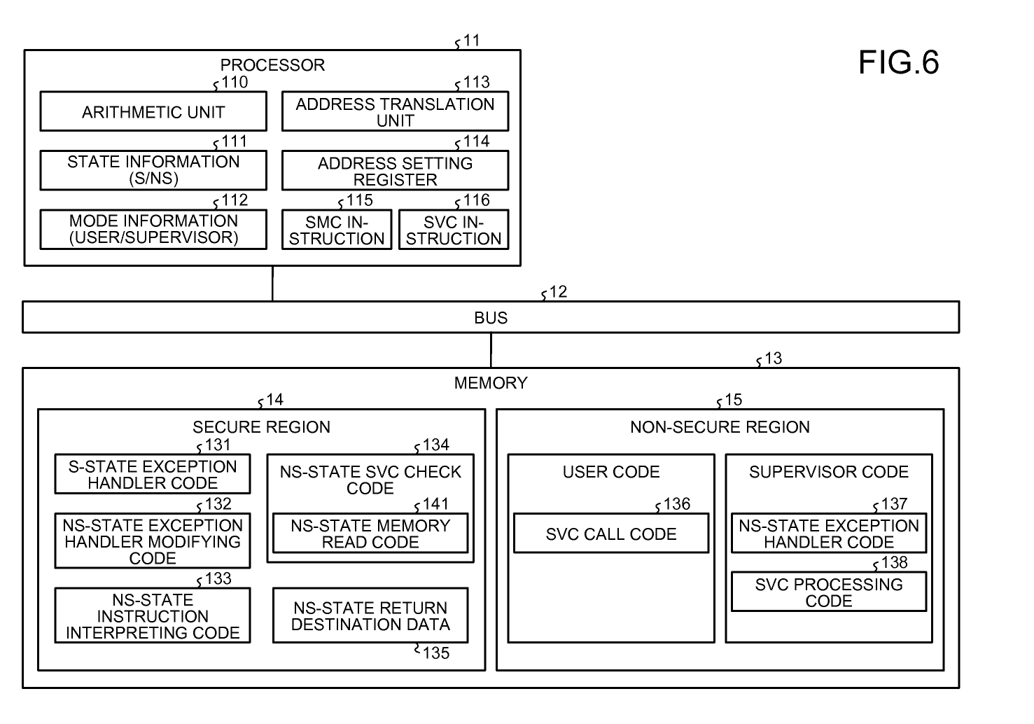

FIG. 6 is a block diagram of the information processing apparatus according to the second embodiment. The same components as the components of the first embodiment are put with the same reference signs and the overlapping descriptions are appropriately omitted.

In the second embodiment, the process for referring to the memory region in the NS-state is added to the process of the NS-state SVC check code 134 in the first embodiment.

The NS-state SVC check code 134 includes an NS-state memory reading code 141 in the second embodiment. The NS-state memory reading code 141 is a program code for reading the data from the memory region in the NS-state. The memory region in the NS-state can be accessed by the processor 11 in the non-secure state and includes a non-secure region 15.

By citing an example in which the invoking of a supervisor call of unlink is check, the process for referring to the memory region in the NS-state will be described. The unlink is one of the instructions implemented in a general-purpose OS to delete the file of a designated name.

The parameter of the supervisor call of the unlink includes a pointer that stores the memory address of the region storing the character string of the file name. The memory address is an NS-state virtual address. In the check of the invoking of the supervisor call, the information about the character string used for the check is obtained by referring to the memory address indicated with the parameter.

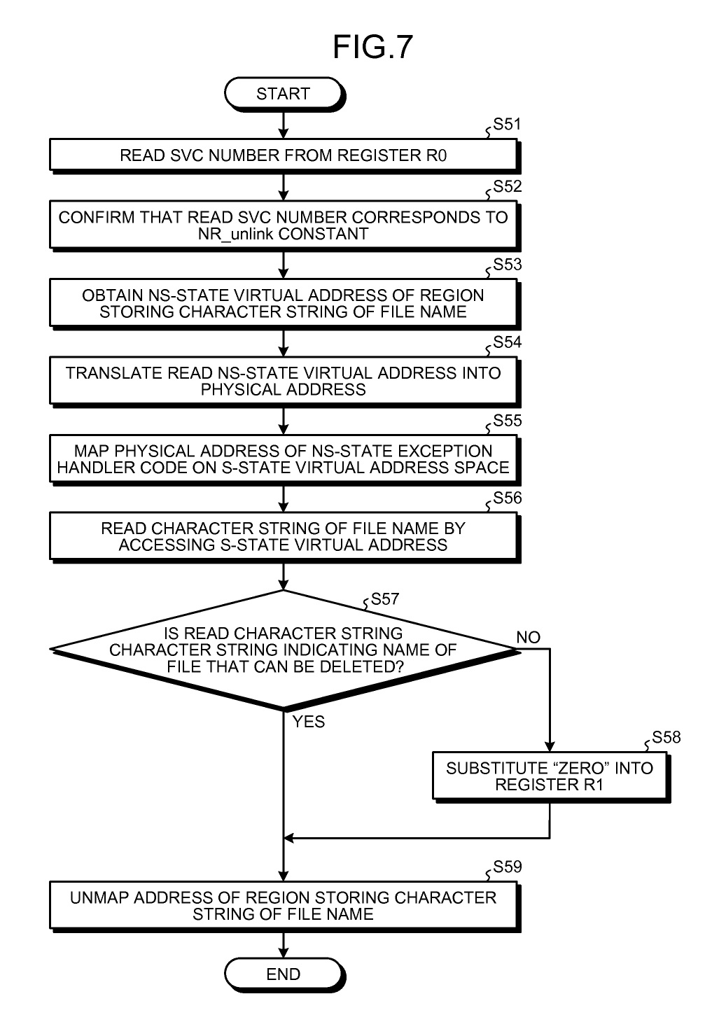

FIG. 7 is a flowchart of the process for referring to the NS-state memory in accordance with the NS-state SVC check code. The process illustrated in FIG. 7 is included in the process by the execution of the NS-state SVC check code 134 in S42 in the first embodiment.

The various registers in the processor 11 in the second embodiment includes the registers R0 and R1. The register R0 stores the SVC number. The register R1 stores a pointer that is a parameter. Note that the relationship between the register and the type of the information stored in the register is in accordance with the calling protocol in the OS.

When the state is switched, the information stored in the registers R0 and R1 is temporarily evacuated to a predetermined memory region. The information can be returned from the memory 13 to the registers R0 and R1 after the state is switched.

The processor 11 reads the SVC number of the supervisor call from the register R0 (S51). When the information in the register R0 is evacuated in the memory region, the SVC number is read from the memory region.

The processor 11 confirms that the read SVC number corresponds to an NR_unlink constant (S52). The NR_unlink constant indicates that the supervisor call of the read SVC number is a supervisor call of the unlink. When confirming that the read SVC number corresponds to the NR_unlink constant, the processor 11 performs the process in and after S53.

When the SVC number does not correspond to the NR_unlink constant, the processor 11 determines that the invoked supervisor call is a supervisor call other than that of the unlink. The processor 11 performs the check in a process other than the process in and after S53 in accordance with the SVC number. The processor 11 can terminate the process in accordance with the NS-state SVC check code 134.

After the confirmation in S52, the processor 11 obtains the NS-state virtual address of the region storing the character string of the file name from the register R1 (S53). When the information in the register R1 is evacuated in the memory region, the NS-state virtual address is read from the memory region.

The address translation unit 113 translates the read NS-state virtual address into the physical address in accordance with the rule of translation in the non-secure state (S54). The address translation unit 113 can translate the NS-state virtual address into the physical address in accordance with the NS-state page table storing the mapping of the NS-state virtual address and the physical address.

The address translation unit 113 maps the obtained physical address on the S-state virtual address space in accordance with the rule of translation in the secure state (S55). The address translation unit 113 can rewrite the S-state page table storing the mapping of the S-state virtual address and the physical address.

After the process in S54 and S55, the processor 11 can read the data from the NS-state memory region and write the data to the memory region in the secure state. The processor 11 reads the character string of the file name from the memory region in the NS-state by accessing the S-state virtual address (S56). The processor 11 executes the NS-state memory reading code 141 to obtain the information from the region storing the character string of the file name.

The processor 11 determines whether the read character string is the character string indicating the file name that can be deleted (S57). The relationship between the file name and whether the file can be deleted is previously stored in a predetermined memory region. The processor 11 determines whether to delete the file in accordance with the relationship.

When determining that the read character string is not the character string indicating the file name that can be deleted (S57, No), the processor 11 substitutes “zero” indicating that the pointer is invalid into the register R1 (S58). When the information in the register R1 is evacuated in the memory region, the value stored in the memory region is replaced with “zero”.

When determining that the read character string is the character string indicating the file name that can be deleted (S57, Yes), the processor 11 performs the process in S59. The processor 11 unmaps the address of the region storing the character string of the file name in S55 (S59). As described above, the process for referring to the NS-state memory in accordance with the NS-state SVC check code 134 is completed.

Similarly to S34 in the first embodiment, the processor 11 performs a process of the supervisor call. When the value in the register R1 is not replaced in S58, the processor 11 performs the process of the supervisor call of the unlink. By this process, the information processing apparatus deletes the file that the processor 11 determines that the name of the file can be deleted from the character string of the file name.

When the value in the register R1 is replaced in S58, the parameter is invalid. Thus, the process of the supervisor call of the unlink fails. Note that, instead of replacement of the value in the register R1, the processor 11 can write another character string over the character string of the file name stored in the NS-state memory region in S58. When the character string is replaced with an invalid character string that does not correspond to any file name, the process of the supervisor call of the unlink also fails.

The process for referring to the NS-state memory in accordance with the NS-state SVC check code 134 can be applied for the check of the invoking of a supervisor call other than the supervisor call of the unlink. The information processing apparatus can determine whether a supervisor call can be executed in accordance with the information stored in the memory region in the NS-state.

The processor 11 according to the second embodiment obtains the information from the memory region that the parameter of the supervisor call indicates. The processor 11 checks the contents of the supervisor call in accordance with the information obtained from the memory region. The information processing apparatus can avoid the operation disadvantageous for security by performing the process in accordance with the check result. The information processing apparatus can determine whether a supervisor call can be executed from more pieces of information by including the information stored in the memory region as the information to be checked. Thus, the information processing apparatus can further enhance the security.

### Third Embodiment

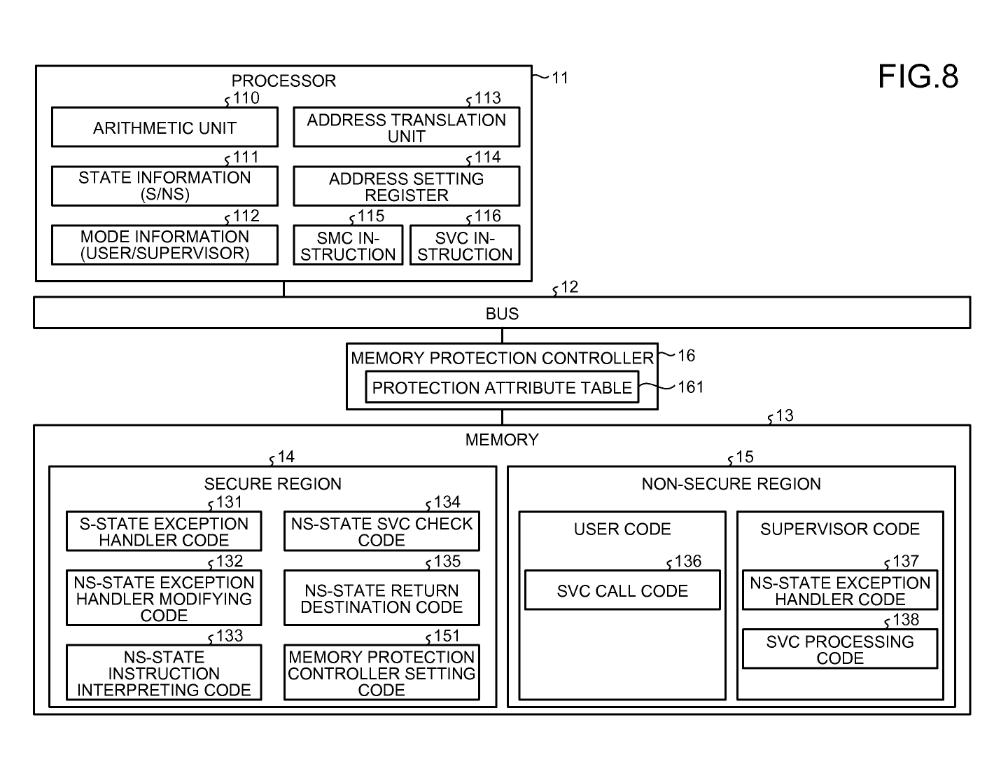

FIG. 8 is a block diagram of the information processing apparatus according to the third embodiment. The same components as the components of the first embodiment are put with the same reference signs and the overlapping descriptions are appropriately omitted.

The information processing apparatus according to the third embodiment includes the configuration for preventing the operation in the non-secure state from modifying the NS-state exception handler code 137 modified in the process in the first embodiment again.

The information processing apparatus according to the third embodiment includes a memory protection controller 16 connected between the bus 12 and the memory 13. The memory protection controller 16 controls the access to the region in the memory 13 in accordance with the security state of the processor 11.

The memory protection controller 16 denies the access to the secure region 14 in the non-secure state and permits the access to the secure region 14 in the secure state. The memory protection controller 16 permits the access to the non-secure region 15 in either of the non-secure state and the secure state. The memory protection controller 16 performs the access limitation set separately by designating the region in addition to the access control to the region.

The NS-state exception handler modifying code 132 includes a memory protection controller setting code 151 in the third embodiment. The memory protection controller setting code 151 is a program code for separately setting the access limitation by designating the region in the memory 13.

The memory protection controller 16 stores a protection attribute table 161. The protection attribute table 161 records the information about the protection attribute separately set in each region in the memory 13.

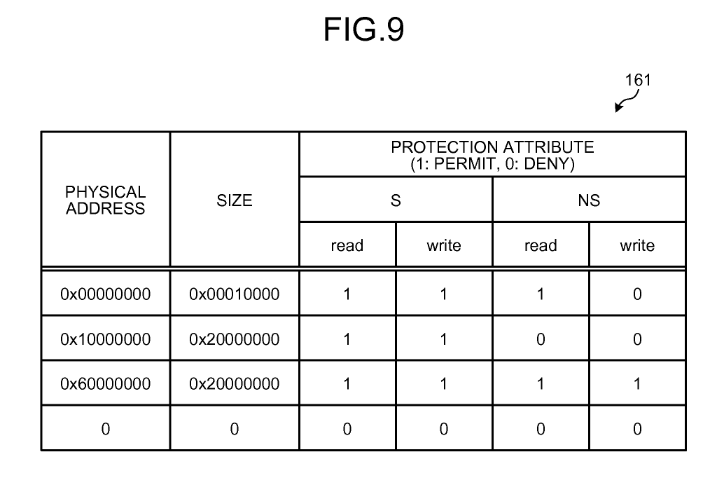

FIG. 9 is a diagram of an exemplary protection attribute table. The “permit” represented as “one” and the “deny” represented as “zero” are set as the protection attribute. The “one” or the “zero” is set for the reading and writing of data in the secure state and the reading and writing of data in the non-secure state. The protection attribute table 161 stores the information about the protection attribute as the combination of the physical address and size indicating the region to be protected. The information is recorded on each row in the protection attribute table 161.

The memory protection controller 16 denies the writing of data to the protection attribute table 161 and the reading of data from the protection attribute table 161 in the non-secure state. The memory protection controller 16 permits the writing of data to the protection attribute table 161 and the reading of data from the protection attribute table 161 in the secure state.

When the processor 11 accesses the memory 13, the memory protection controller 16 receives a request including the address, the type of access, and the information about the state through the bus 12. The type of access is one of the reading of date (read) or the writing of data (write). When the type of access is “write”, the request includes the data to be written in the memory 13. The information about state is identical to the state information 111 stored in the processor 11.

When receiving the request from the bus 12, the memory protection controller 16 refers to the protection attribute table 161. The memory protection controller 16 determines whether the protection attribute table 161 includes the information including the address in the request.

When the protection attribute table 161 includes the information including the address in the request, the memory protection controller 16 checks the information about the protection attribute with the type of access and the information about state in the request. As the result of the check, when the access is to be permitted, the memory protection controller 16 transmits the request to the memory 13. When the access is to be denied, the memory protection controller 16 sends an error notification back to the bus 12 without transmitting the request to the memory 13.

The information processing apparatus according to the third embodiment sets the access limitation that limits the modifying of data in the region in which the instruction is replaced in the NS-state exception handler code 137. The information processing apparatus records the information used for the access limitation in the protection attribute table 161 while performing the process for modifying the NS-state exception handler code 137. The processor 11 executes the memory protection controller setting code 151 to update the protection attribute table 161

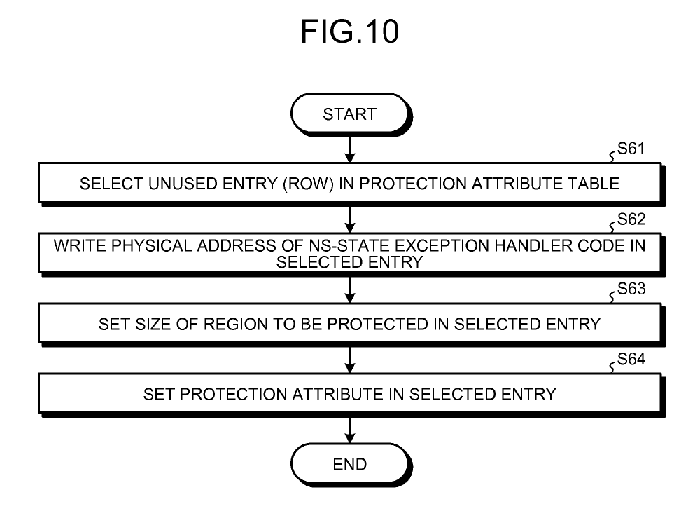

FIG. 10 is a flowchart of the process for setting an access limitation by executing the memory protection controller setting code. The process illustrated in FIG. 10 is performed between the unmapping in S18 and the execution of the SMC instruction in S19 in the first embodiment.

When finishing the unmapping in S18, the processor 11 executes the memory protection controller setting code 151 to perform the process from S61 to S64.

The processor 11 selects an unused entry in the protection attribute table 161 (S61). The unused entry is a row on which valid information is not recorded. In the example illustrated in FIG. 9, the fourth row on which the column of the size records “zero” is the unused entry.

The processor 11 translates the NS-state virtual address of the NS-state exception handler code 137 into a physical address with the address translation unit 113 in S12 in the first embodiment. The processor 11 writes the physical address obtained in S12 in the column of the physical address of the selected entry (S62). In the example illustrated in FIG. 3, the processor 11 writes the physical address translated from the NS-state virtual address “0xffff0000” in the entry.

The processor 11 sets the size of the region to be protected in the column of the size of the selected entry (S63). The processor 11 replaces the instruction in the supervisor call handler in the NS-state exception handler code 137 with the SMC instruction in S17 in the first embodiment. The processor 11 sets the size such that the range from the position of the set physical address to the region in which the instruction is replaced in S17 is included in the data to be protected.

In the example illustrated in FIG. 3, the range from the address “0xffff0000” to the handler “svc_handler:” in which the instruction is replaced, for example, “0x20” is set as the size.

The processor 11 sets the protection attribute in the selected entry (S64). The processor 11 sets the protection attribute indicating that the reading and writing of data in the secure state is permitted, the reading of data in the non-secure state is permitted, and the writing of data in the non-secure state is denied. In this case, “one”, “one”, “one”, and “zero” is written in the columns S (read), S (write), NS (read), and NS (write) illustrated in FIG. 9, respectively.

After that, the process for setting an access limitation by executing the memory protection controller setting code 151 is completed. The processor 11 performs the process in S19 in the first embodiment, subsequently to the process in S64.

By setting the access limitation, the information processing apparatus prevents the operation in the non-secure state from modifying the data in the region in which the instruction is replaced in the NS-state exception handler code 137.

The information processing apparatus according to the third embodiment executes the memory protection controller setting code 151 to set the access limitation on the region in which the instruction is replaced in the NS-state exception handler code 137. The information processing apparatus prevents the operation in the non-secure state from modifying the NS-state exception handler code 137 again. The information processing apparatus can further enhance the security by maintaining the function to check a supervisor call.

### Fourth Embodiment

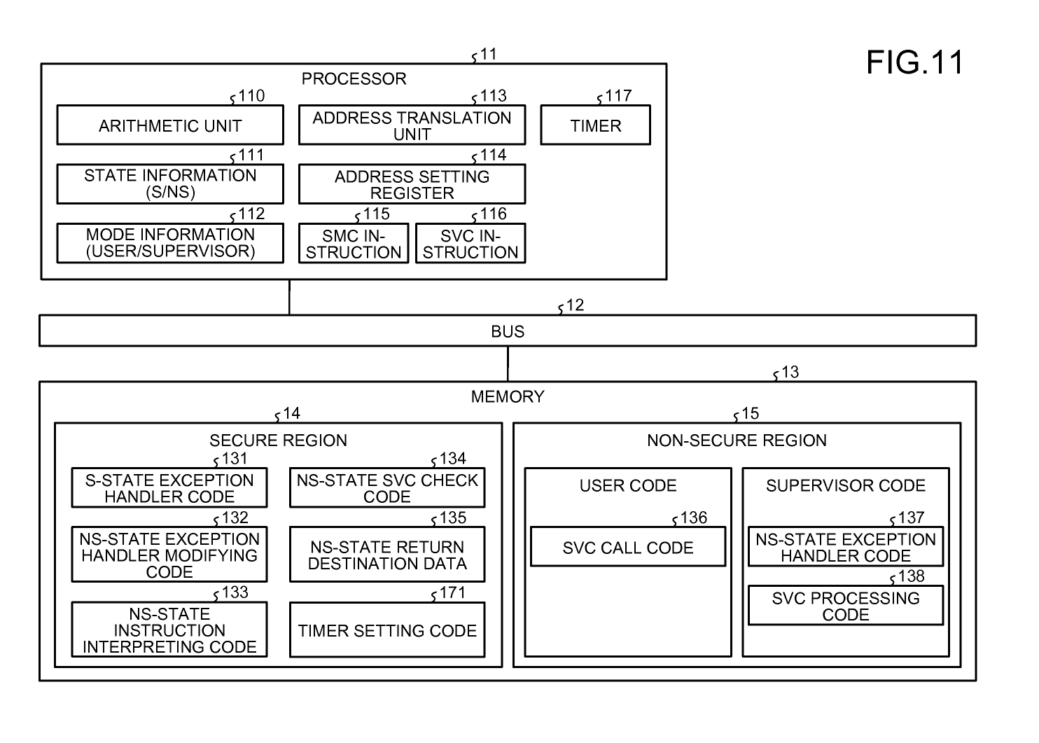

FIG. 11 is a block diagram of the information processing apparatus in the fourth embodiment. The same components as the components of the first embodiment are put with the same reference signs and the overlapping descriptions are appropriately omitted.

The information processing apparatus according to the fourth embodiment can modify the NS-state exception handler code 137 not only in response to the invoking of a secure monitor call but also in response to another reason. In the fourth embodiment, the information processing apparatus performs the process for modifying the NS-state exception handler code 137 in response to a timer interruption in addition to the invoking of a secure monitor call. The information processing apparatus according to the fourth embodiment includes the configuration to generate a timer interruption in addition to the first embodiment.

The information processing apparatus according to the fourth embodiment includes a timer 117 inside the processor 11. The timer 117 measures time to generate a timer interruption when a predetermined period of time has elapsed.

Instead of the timer 117 inside the processor 11, the information processing apparatus can be provided with a time outside the processor 11. The timer outside the processor 11 is connected to the bus 12 to give an instruction for a timer interruption through the bus 12 to the processor 11. In such a case, except that the information processing apparatus gives an instruction for a timer interruption from the outside of the processor 11, the information processing apparatus operates in the same manner as when the information processing apparatus includes the timer 117 inside the processor 11.

In the fourth embodiment, the timer setting code 171 is placed in the secure region 14. The timer setting code 171 is read in the memory 13 from an external storage unit (not illustrated) and is developed in the memory 13 when the information processing apparatus starts. The timer setting code 171 is a program code for setting the operation of the timer 117.

After the processor 11 starts, the processor 11 reads the timer setting code 171 from the secure region 14 during the initialization in the secure state and before the transition to the non-secure state. The processor 11 executes the timer setting code 171 to set the operation of the timer 117 in accordance with the contents of the timer setting code 171. The timer setting code 171 includes an instruction for generating a timer interruption every time a predetermined period of time has elapsed.

When the processor 11 operates in the non-secure state and a timer interruption is generated, the information processing apparatus switches the processor 11 to the secure state. When an interruption set in the secure state is generated in the operation in the non-secure state, the processor 11 is switched from the non-secure state to the secure state. This switch is prescribed as a hardware specification.

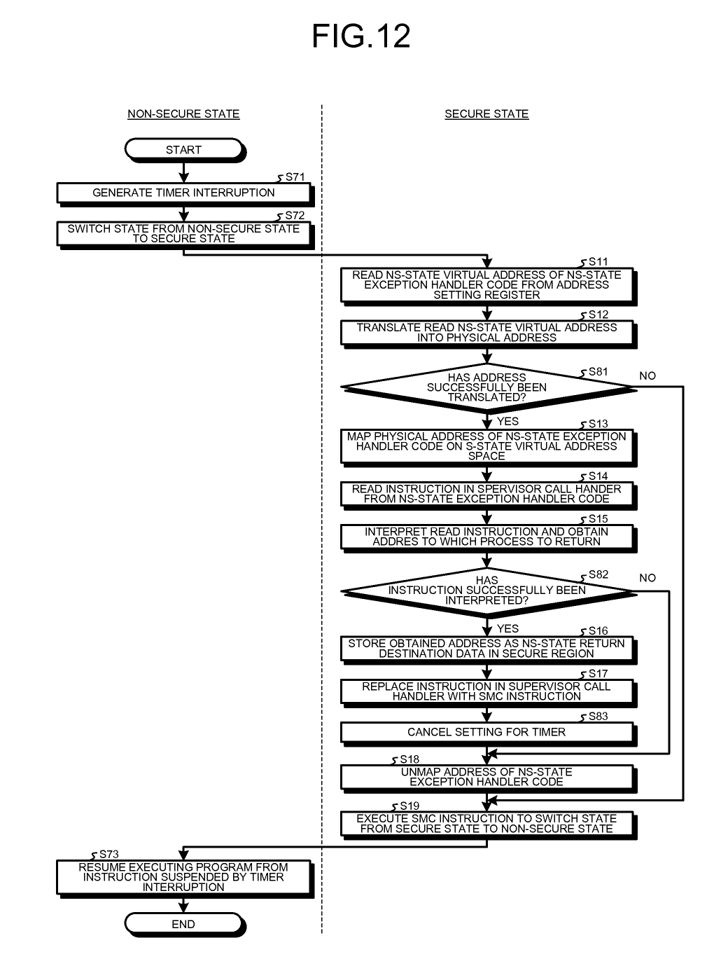

FIG. 12 is a flowchart of a process for modifying the NS-state exception handler code in response to the interruption by the timer. After a predetermined period of time has elapsed in the operation in the non-secure state, the timer 117 generates a timer interruption (S71).

The processor 11 forcibly suspends the process in progress in response to a timer interruption (S72). The processor 11 switches the non-secure state to the secure state. The processor 11 calls the S-state exception handler code 131 from the secure region 14 in the secure state.

The processor 11 executes the called S-state exception handler code 131 to call the NS-state exception handler modifying code 132 from the secure region 14. The processor 11 executes the NS-state exception handler modifying code 132 to perform the same process in S11 to S19 as the first embodiment. In the fourth embodiment, the process in S81, S82, and S83 is added to the process by executing the NS-state exception handler modifying code 132.

The processor 11 reads the NS-state virtual address (S11), and translates the address (S12). Subsequently to the process in S12, the processor 11 determines whether the address is successfully translated in S12 (S81).

When the address is successfully translated (S81, Yes), the processor 11 maps the address (S13), reads the instruction from the NS-state exception handler code 137 (S14), and obtains the return destination address (S15). Subsequently to the process in S15, the processor 11 determines whether the instruction in S15 is successfully interpreted (S82).

When the instruction is successfully interpreted (S82, Yes), the processor 11 stores the return destination address (S16), and replaces the instruction (S17).

Subsequently to the process in S17, the processor 11 cancels the setting for the timer 117 (S83). Then, the processor 11 unmaps the address of the NS-state exception handler code 137 (S18), and switches the state (S19).

When the interpretation of the instruction in S15 fails (S82, No), the processor 11 skips the processes in S16, S17, and S83 and performs the process in and after S18.

When the translation of the address in S12 fails (S81, No), the processor 11 skips the process in S13 to S18 and performs the process in and after S19.

Subsequently to the process in S19, the processor 11 resumes executing the program in the non-secure state from the instruction suspended by the timer interruption (S73). The fourth embodiment resumes the process from the instruction suspended by the timer interruption. This is different from the first embodiment that resumes the process from the instruction next to the SMC instruction 115. After the process described above, the processor 11 completes a series of the processes when a timer interruption is generated.

A timer interruption may be generated before the exception handler is initialized in the non-secure state. When a timer interruption is generated before the exception handler is initialized, one of the translation of the address (S12) and the interpretation of the instruction (S15) fails.

When failing to translate the address or interpret the instruction, the processor 11 resumes the process in the non-secure state without modifying the NS-state exception handler code 137. In this case, when a timer interruption is generated again, the processor 11 attempts to modify the NS-state exception handler code 137 again. By the determination in S81 and S82, the processor 11 can avoid the modifying process when the exception handler is not initialized.

Even when a secure monitor call is not invoked, the information processing apparatus can activate the function to check a supervisor call when a predetermined period of time has elapsed. The processor 11 can modify the NS-state exception handler code 137 in response to an interruption other than a timer interruption.

In the fourth embodiment, the information processing apparatus performs the process for modifying the NS-state exception handler code 137 in response to the occurrence of an interruption. Even when a secure monitor call is not invoked, the information processing apparatus can activate the function to check a supervisor call when an interruption is generated. The information processing apparatus can further enhance the security by checking a supervisor call regardless of the presence or absence of the invoking of a secure monitor call.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising:
a processor configured to operate in a first state and a second state, the processor switching the first state and the second state, the second state having a security level lower than that of the first state; and
a memory including a first region and a second region, the processor in the first state accessing the first region, the processor in the second state accessing the second region,
a first program code being written in the second region, the first program code being executed when a call of a function provided by an operation system is invoked,
a second program code being written in the first region, the second program code being for modifying the first program code, wherein
the processor executes the second program code to replace a first instruction in the first program code with a second instruction, the second instruction being for switching the second state and the first state.

2. The information processing apparatus according to claim 1, wherein
the processor interprets the first instruction in execution of the second program code, and stores data obtained by the interpretation in the first region.

3. The information processing apparatus according to claim 1, wherein
the processor switches an operation between a first mode and a second mode, the operation is limited in the second mode in comparison with the first mode, and
the processor executes the second instruction included in the first program code when the call is invoked in the second mode.

4. The information processing apparatus according to claim 1, wherein
a check code used to check contents of a process requested in the call is written in the first region, and
the processor executes the second instruction to switch the second state to the first state and then executes the check code when the call is invoked in the second state.

5. The information processing apparatus according to claim 4, wherein
the check code includes a read code used to read data from a memory region that the processor can access in the second state.

6. The information processing apparatus according to claim 1, further comprising:
a controller configured to control access to a region in the memory, wherein
the processor sets, in the controller, an access limitation used to deny modifying of data in a region in which the first instruction is replaced with the second instruction.

7. The information processing apparatus according to claim 4, further comprising:
a controller configured to control access to a region in the memory, wherein
the check code includes a setting code used to set an access limitation on a region designated in the memory, and
the processor executes the setting code to set, in the controller, an access limitation used to deny modifying of data in a region in which the first instruction is replaced with the second instruction.

8. The information processing apparatus according to claim 1, wherein
the processor executes the second program code when the second state is switched to the first state.

9. The information processing apparatus according to claim 1, further comprising:
a timer configured to generate a time interruption, wherein
the processor switches the second state to the first state and executes the second program code when the processor operates in the second state and the timer generates the timer interruption.

10. The information processing apparatus according to claim 4, wherein
the processor checks a parameter obtained by the call in execution of the check code, and rewrites the parameter in accordance with a result from the check.

11. The information processing apparatus according to claim 1, wherein
the processor includes an address translation unit, the address translation unit translating a virtual address of the first program code into a physical address in accordance with a rule of translation in the second state, and mapping the physical address on a virtual address space in accordance with a rule of translation in the first state.

12. The information processing apparatus according to claim 5, wherein
the processor includes an address translation unit, the address translation unit translating a virtual address in a region storing the data in the memory region into a physical address in accordance with a rule of translation in the second state, and mapping the physical address on a virtual address space in accordance with a rule of translation in the first state, the virtual address being included in a parameter obtained by the call.

13. A program execution method comprising:
switching a second state to a first state in a processor, the second state having a security level lower than that of the first state;
reading a second program code used to modify a first program code from a first region, the first program code being executed when a call of a function provided by an operation system is invoked and being read from a second region, the first region being a memory region that the processor in the first state accesses, the second region being a memory region that the processor in the second state accesses; and
executing the second program code to replace a first instruction included in the first program code with a second instruction, the second instruction being for switching the second state and the first state.

14. The program execution method according to claim 13, further comprising:
interpreting the first instruction in execution of the second program code; and
storing data obtained by the interpretation in the first region.

15. The program execution method according to claim 13, further comprising:
executing the second instruction included in the first program code when the call is invoked in the second mode.

16. The program execution method according to claim 13, further comprising:
writing a check code in the first region, the check code being used to check contents of a process requested by using the call; and
switching the second state to the first state by executing the second instruction to execute the check code when the call is invoked in the second mode.

17. The program execution method according to claim 16, wherein
a read code used to read data from a memory region that the processor is capable of accessing in the second state is included in the check code.

18. The program execution method according to claim 13, further comprising:
setting an access limitation to deny modifying of data in a region in which the first instruction is replaced with the second instruction.

19. The program execution method according to claim 16, further comprising:
executing a setting code to set an access limitation to deny modifying of data in a region in which the first instruction is replaced with the second instruction, the setting code being used to set an access limitation on a region designated in the memory, the check code including the setting code.

20. The program execution method according to claim 13, wherein
the second state is switched to the first state in the processor and the second program code is executed in response to an interruption generated when the processor operates in the second state.
